(19) United States
(12) Patent Application Publication
(10) Pub. No.: US 2008/0153545 A1
(43) Pub. Date: Jun. 26, 2008

(54) Assembly device for extending functions of a cellular phone

(75) Inventor: Pen-Lo Wang, Longtan Township (TW)

Correspondence Address: TROXELL LAW OFFICE PLLC;SUITE 1404, 5204 LEESBURG PIKE, FALLS CHURCH, VA, 22041, US

(73) Assignee: A-Men Technology Corporation

(21) Appl. No.: 11/645,037

(22) Filed: Dec. 26, 2006

(51) Int. Cl. H04M 1/00

(52) U.S. Cl. 455/558

(57) ABSTRACT

An assembly device for extending functions of a cellular phone is composed primarily of a cellular phone, a subscriber identity module (SIM) device, a registration server, and a service server, wherein the SIM device of the cellular phone can be installed without changing a SIM card through a cutting method, such that when the cellular phone subscriber uses a new SIM card, an application service function can be extended by an installation of the SIM device, and through the registration server and the service server.

### BACKGROUND OF THE INVENTION

(a) Field of the Invention

The present invention relates to an assembly device for extending functions of a cellular phone, and more particularly to an assembly device wherein a SIM (Subscriber Identity Module) device of the cellular phone can be extended without changing a SIM card by cutting the SIM card.

(b) Description of the Prior Art

Cellular phones sold in the existing market are not provided with subscriber identity module devices, which results in that many sets of subscriber numbers cannot be stored through a registration server, and the subscribers cannot enter personal preferences on-line by an automatic guidance, thereby further prohibiting cellular phone vendors from correctly transmitting related messages according to the subscribers' personal preferences.

Moreover, for internationally well-known portal sites, such as Yahoo, Google, and MSN, their marketing services are only limited to existing computer groups and are not able to extend to cellular phone subscribers, such as farmers and fishermen, who do not use the computers, due to that the existing cellular phones are not provided with the subscriber identity module devices.

Therefore, how to eliminate the aforementioned problems is a technical issue to be solved by the present inventor.

### SUMMARY OF THE INVENTION

The primary object of present invention is to provide an assembly device for extending functions of a cellular phone, wherein a SIM (Subscriber Identity Module) device of the cellular phone can be extended without changing a SIM card by cutting the SIM card, such that when the cellular phone subscriber uses a new SIM card, an application service function can be extended by an installation of the SIM module, and through a registration server and a service server.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention.

FIG. 2 shows a block diagram of the present invention.

FIG. 3 shows a first schematic view of an installation of the present invention.

FIG. 4 shows a second schematic view of an installation of the present invention.

FIG. 5 shows a third schematic view of an installation of the present invention.

FIG. 6 shows a first schematic view of an embodient of the present invention.

FIG. 7 shows a second schematic view of an embodient of the present invention.

FIG. 8 shows a third schematic view of an embodient of the present invention.

FIG. 9 shows a schematic view of a further embodient of the present invention.

### DETAILED DESCRIPTION OF THE PREFERRED EMBODIMENTS

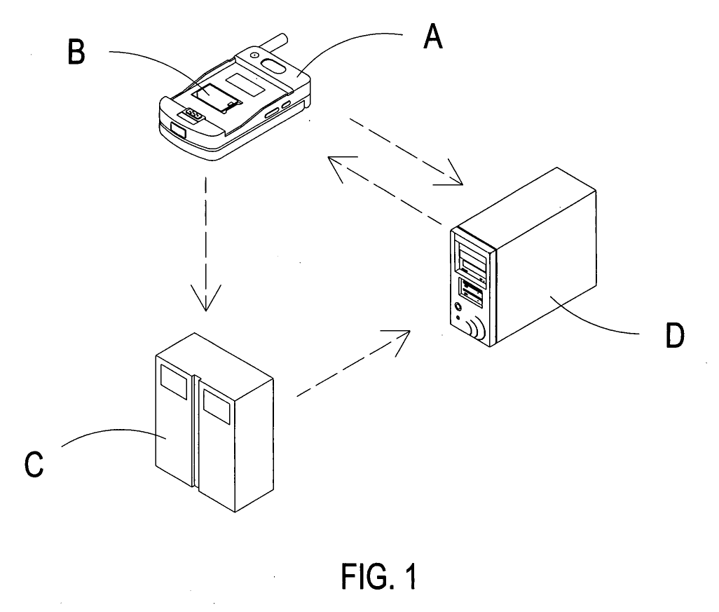

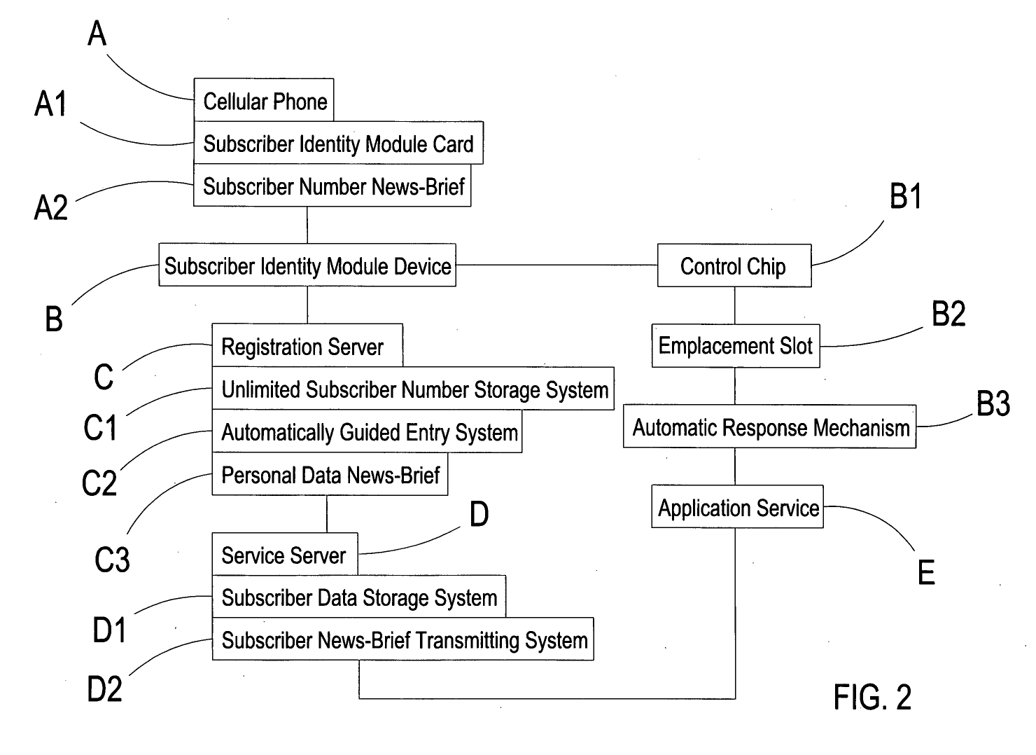

Referring to FIG. 1 and FIG. 2, the present invention is to provide an assembly device for extending functions of a cellular phone, which is constituted primarily by a cellular phone A, a SIM (Subscriber Identity Module) device B, a registration server C, and a service server D, wherein the cellular phone A includes a SIM card A1, and a subscriber number news-brief A2; the SIM device B includes a control chip B1, an emplacement slot B2, and an automatic response mechanism B3; the registration server C includes an unlimited subscriber number storage system C1, an automatically guided entry system C2, and a personal data news-brief C3; and the service server D includes a subscriber data storage system D1 and a subscriber news-brief transmitting system D2.

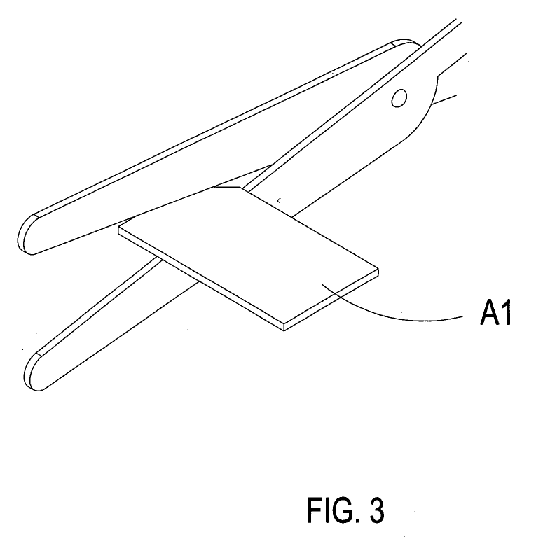

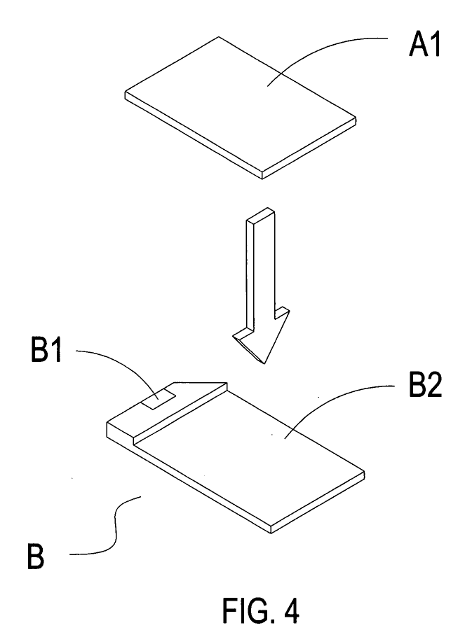

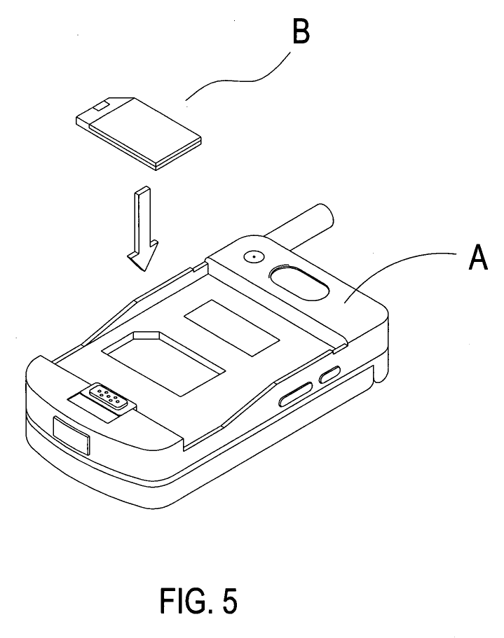

Through a cutting method, the SIM device B of the cellular phone A can be installed without changing a SIM card (as shown in FIGS. 3 to 5). When a cellular phone subscriber needs to use a new SIM card A1, a function of application service E can be extended by installing the SIM device B, and through the registration server C and the service server D.

Referring to FIGS. 3 to 5, when the cellular phone A subscriber needs to use the SIM device B, the SIM card A1 is cut to fit a size of the emplacement slot B2 of the SIM device B, and then the SIM card A1 is attached to the emplacement slot B2 of the SIM device B to be fixed into one body. Finally, they are emplaced into the cellular phone A, and the installation of the SIM device B is accomplished. In addition, the SIM device B can be further installed by implanting a chip into the cellular phone A, changing a firmware of the cellular phone A, or using other related method.

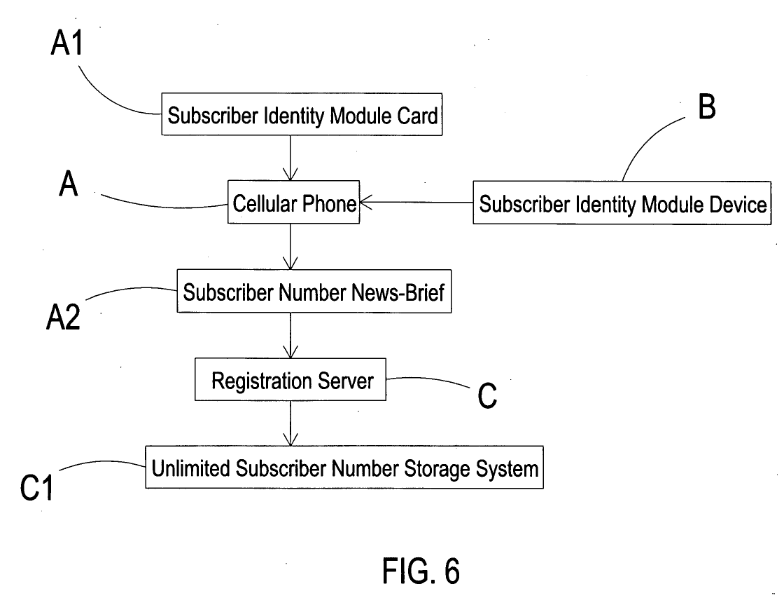

Referring to FIG. 6, by installing the SIM device B into the cellular phone A, when the subscriber changes the SIM card A1, the cellular phone A will automatically transmit back the subscriber number news-brief A2 to the unlimited subscriber number storage system C1 of the registration server C, which provides for a storage of the subscriber numbers, with a best amount of the subscriber numbers being 5˜10.

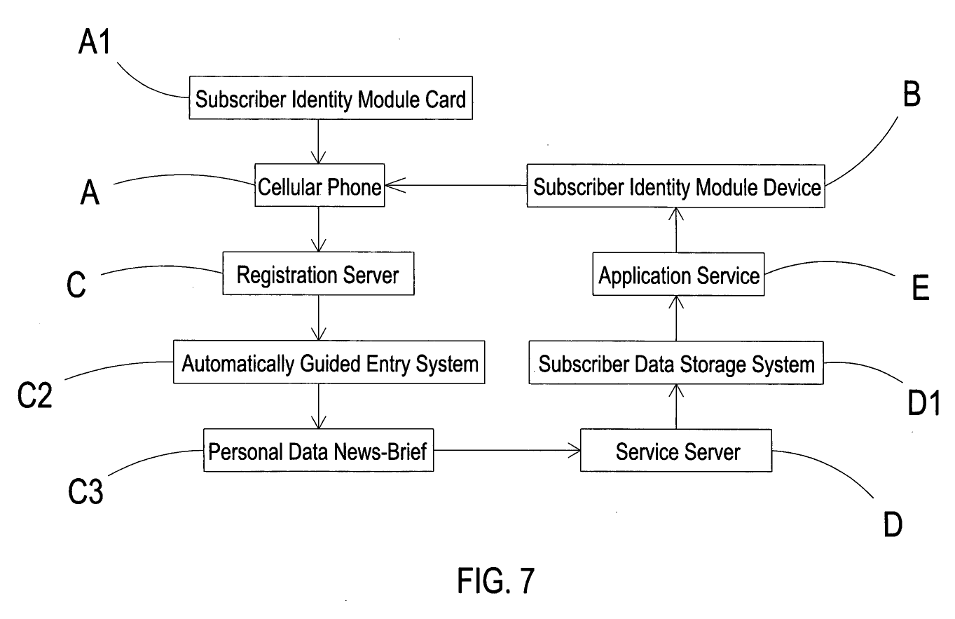

Referring to FIG. 7, through the installation of the SIM device B into the cellular phone A, when the subscriber changes the SIM card A1, the cellular phone A will automatically guide the subscriber to enter personal preferences on-line, through the automatically guided entry system C2 of the registration server C, and transmit the personal data news-brief C3 to the subscriber data storage system D1 of the service server D for providing an utilization to the following application service E.

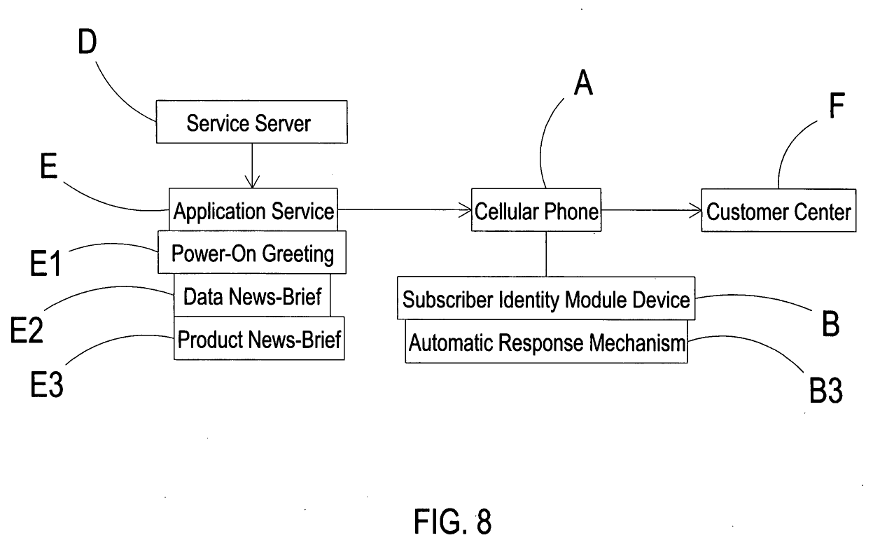

Referring to FIG. 8, through the installation of the SIM device B into the cellular phone A, cellular phone vendors can use the service server D to transmit the application service E to the subscriber of the cellular phone A. The application service E includes a power-on greeting E1, a data news-brief E2, a product news-brief E3, and other related subscriber's preference. The SIM device B of the cellular phone A is installed with the automatic response mechanism B3, such that the cellular phone A can automatically dial to a customer center F to provide a direct on-line consultation to the subscriber and to proceed with purchasing.

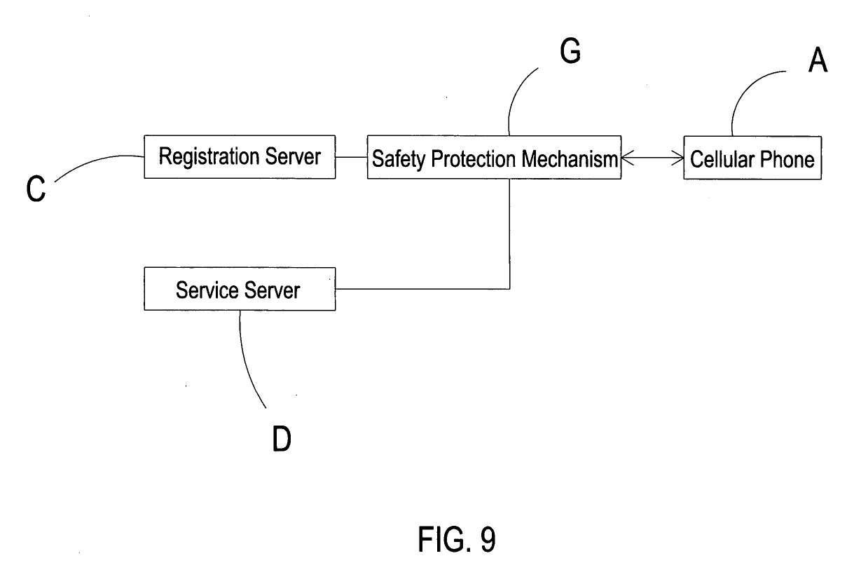

Referring to FIG. 9, the registration server C and the service server D are further provided with a safety protection mechanism G, such that when the subscriber informs the customer center F that the cellular phone A has been lost, data entered by the subscriber can be deleted through the safety protection mechanism G.

To further manifest the advancement and practicability of the present invention, the present invention is compared with a conventional device as follow.

Shortcomings of the Conventional Device
1. It is not provided with the subscriber identity module device, resulting in that many sets of subscriber numbers cannot be stored through the registration server.
2. According to item 1, the subscriber cannot be automatically guided to enter personal preferences on-line through the registration server.
3. According to item 1, the cellular phone vendors cannot correctly transmit related messages according to the subscriber's personal preferences.
4. According to item 1, the marketing service of the internationally well-known portal sites cannot be extended to the cellular phone subscribers, such as farmers and fishermen, who do not use computers, through the service server.

Advantages of the Present Invention
1. It is installed with the subscriber identity module device; therefore, many sets of subscriber numbers can be stored through the registration server.
2. According to item 1, the subscriber identity module device is provided with the mechanism for automatically transmitting back the cellular phone number; this mechanism can serve as a following value-added application and service.
3. According to item 1, the subscriber can be guided automatically to enter the personal preferences on-line through the registration server.
4. According to item 1, the cellular phone vendors can correctly transmit the related messages according to the subscriber's personal preferences.
5. According to item 1, the marketing service of the internationally well-known portal sites can be extended to the cellular phone subscribers, such as farmers and fishermen, who do not use the computers, through the service server.
6. The subscriber identity module device is provided with the automatic response mechanism, such that the cellular phone can automatically dial to the customer center for providing a direct on-line consultation to the subscriber and for proceeding with purchasing.
7. The registration server and the service server are further installed with the safety protection mechanism, such that when the subscriber informs the customer center that the cellular phone has been lost, the data entered by the subscriber will be immediately deleted.
8. It is provided with the advancement and practicability.
9. It can improve industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An assembly device for extending functions of a cellular phone comprising a cellular phone, a SIM (Subscriber Identity Module) device, a registration server, and a service server, wherein the cellular phone includes a SIM card; the SIM device includes a control chip, an emplacement slot, and an automatic response mechanism; the registration server includes an unlimited subscriber number storage system and an automatically guided entry system; and the service server includes a subscriber data storage system and a subscriber news-brief transmitting system; the SIM device of the cellular phone being installed without changing a SIM card through a cutting method, such that when the cellular phone subscriber uses a new SIM card, an application service function is extended by an installation of the SIM device, and through the registration server and the service server.

2. The assembly device for extending functions of a cellular phone according to claim 1, wherein the SIM device is installed by further implanting a chip into the cellular phone, changing a firmware of the cellular phone, or other related method.

3. The assembly device for extending functions of a cellular phone according to claim 1, wherein the best number of sets of subscriber numbers stored in the unlimited subscriber number storage system is 5˜10.

4. The assembly device for extending functions of a cellular phone according to claim 1, wherein the automatically guided entry system directly guides the subscriber to enter personal preferences on-line for providing utilization to a following application service.

5. The assembly device for extending functions of a cellular phone according to claim 1, wherein the application service includes a power-on greeting, a data news-brief, a product news-brief, and other related subscriber's preference, and the subscriber's preference information is directly displayed on a screen of the cellular phone and is deleted without pressing buttons, through the SIM device.

6. The assembly device for extending functions of a cellular phone according to claim 1, wherein the registration server and the service server are further provided with a safety protection mechanism, such that when the subscriber informs a customer center that the cellular phone has been lost, data entered by the subscriber is immediately deleted.

7. The assembly device for extending functions of a cellular phone according to claim 1, wherein the SIM device is further installed with a third generation universal subscriber identity module (3G USIM) card.
